(19) United States
(12) Patent Application Publication
(10) Pub. No.: US 2007/0050100 A1
(43) Pub. Date: Mar. 1, 2007

(54) Auto-control override system for aircraft

(76) Inventors: Eric S. Gustafson, Tucson, AZ (US); Marlyn Zonnefeld, Tucson, AZ (US)

Correspondence Address: DALE F. REGELMAN, LAW OFFICE OF DALE F. REGELMAN, P.C., 4231 SOUTH FREMONT AVENUE, TUCSON, AZ, 85714, US

(21) Appl. No.: 11/404,470

(22) Filed: Apr. 13, 2006

Related U.S. Application Data
(60) Provisional application No. 60/688,559, filed on Jun. 8, 2005.

(51) Int. Cl. G01C 23/00

(52) U.S. Cl. 701/3; 701/4

(57) ABSTRACT

A method, article of manufacture, and a computer program product, are disclosed to control the operation of an aircraft in flight, where the aircraft comprises a database comprising the location of one or more airports, an automated flight control system, a cockpit crew interface, and a first data bus interconnecting the automated flight control system and the cockpit crew interface. Upon detecting either that one or more unauthorized persons have taken command and control of the aircraft or that the flight crew is unable to operate the aircraft, the method, article of manufacture, and/or computer program product, interrupts the first data bus while the aircraft is in flight such that no signals originating from said cockpit crew interface are received by the automated flight control system, selects a diversion airport from the database, causes the aircraft to fly to that diversion airport, and causes the aircraft to attempt to land at the diversion airport.

### CROSS REFERENCE TO RELATED APPLICATIONS

This Application claims priority from a U.S. Provisional Application having Ser. No. 60/688,559.

### FIELD OF THE INVENTION

The invention is directed to an apparatus and method to override all command and control signals from an aircraft cockpit, automatically navigate the aircraft to a diversion airport, and attempt to land that aircraft on a selected runway.

### BACKGROUND OF THE INVENTION

An automated flight control system integrates the information provided by a plurality of individual flight instruments to provide automated control of an aircraft's flight path. A pre-programmed path, automatically computed, furnishes the steering commands necessary to obtain and hold a desired path.

Such an automated flight control system receives information from sensor systems which include, without limitation, on-board navigation instruments, one or more attitude gyros, one or more radar altimeters, one or more compass systems, and or more barometric sensors, and the like. That automated flight control system further receives control inputs from cockpit crew interfaces. The automated flight control system utilizes these sensor inputs and control inputs to automatically operate actuator systems to, among other things and without limitation, fly a pre-selected heading, fly a predetermined pitch attitude, maintain altitude, intercept a selected VOR or localizer track, and maintain that track, fly an ILS glide slope, and the like.

What is needed is an automated flight control system that can detect that one or more unauthorized persons have seized command and control of the aircraft, and/or can detect that the flight crew is unable to operate the aircraft, and automatically take control of the aircraft, select a nearby airport, navigate to that nearby airport, and attempt to land at that nearby airport.

### SUMMARY OF THE INVENTION

Applicants' invention comprises a method, article of manufacture, and a computer program product, to control the operation of an aircraft in flight, where the aircraft comprises a database comprising the location of one or more airports, an automated flight control system, a cockpit crew interface, and a first data bus interconnecting the automated flight control system and the cockpit crew interface.

Upon detecting either that one or more unauthorized persons have taken command and control of the aircraft or that the flight crew is unable to operate the aircraft, the method, article of manufacture, and/or computer program product, interrupts the first data bus while the aircraft is in flight such that no signals originating from said cockpit crew interface are received by the automated flight control system, selects a diversion airport from the database, causes the aircraft to fly to that diversion airport, and causes the aircraft to attempt to land at the diversion airport.

### BRIEF DESCRIPTION OF THE DRAWINGS

The invention will be better understood from a reading of the following detailed description taken in conjunction with the drawings in which like reference designators are used to designate like elements, and in which:

FIG. 1 is a block diagram showing a prior art automated flight control system;

FIG. 2 is a block diagram showing Applicants' automated flight control system which comprises Applicants' auto-control override system;

FIG. 3 is a flow chart summarizing the steps of Applicants' method to override all command and control signals from an aircraft cockpit, automatically navigate that aircraft to a diversion airport, and attempt to land that aircraft on a selected runway, using the automated flight control system of FIG. 2

### DETAILED DESCRIPTION OF THE PREFERRED EMBODIMENTS

Virtually all commercial aircraft are modernly equipped with a plurality of navigation and flight control instruments and systems. Such aircraft are capable of determining a current position and altitude using signals received from ground transmitters, including without limitation ILS, Localizer, VOR, VORTAC, MLS, signals and the like. In addition, many aircraft are capable of determining a current position and altitude using signals received from a plurality of GPS satellites. Moreover, many aircraft are capable of determining a current position and altitude using only on-board equipment such as inertial navigation systems.

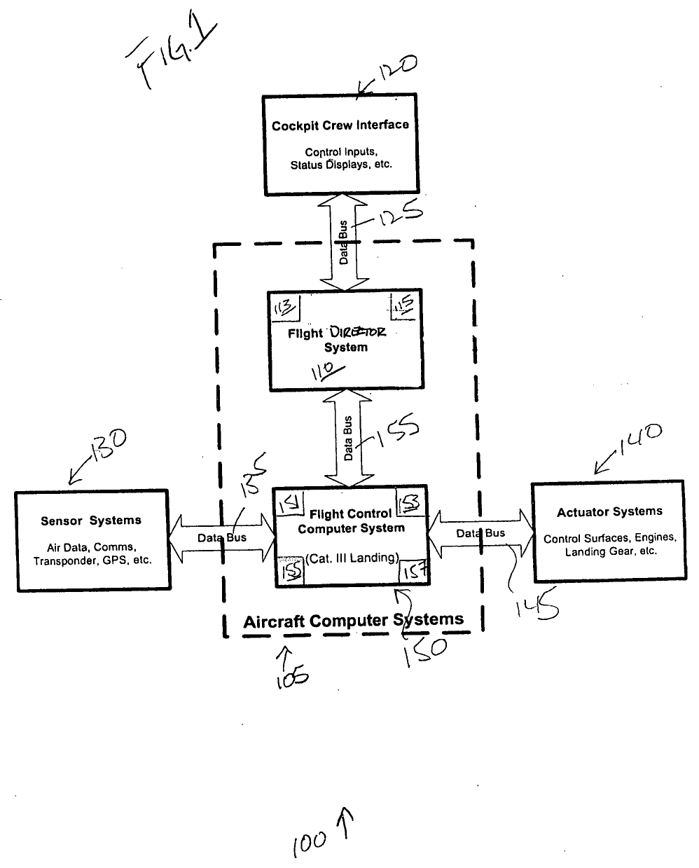

Applicants' invention is described in preferred embodiments in the following description with reference to the Figures, in which like numbers represent the same or similar elements. FIG. 1 is a block diagram showing the elements typically found in an automated flight control system (AFCS), such as AFCS 105. AFCS 105 integrates the information provided by, inter alia, a plurality of instruments to provide automated control of the aircraft's flight path. The pre-programmed path, automatically computed, furnishes the steering commands necessary to obtain and hold a desired path.

AFCS 105 receives information from sensor systems 130 which include, without limitation on-board navigation instruments, one or more attitude gyros, one or more radar altimeters, one or more compass systems, and or more barometric sensors, and the like. AFCS 105 further receives control inputs from cockpit crew interfaces 120. AFCS 105 utilizes the inputs from systems 130 and control inputs from interface 120, to automatically operate actuator systems 140 to, among other things and without limitation fly a selected heading, fly a predetermined pitch attitude, maintain altitude, intercept a selected VOR or localizer track, and maintain that track, fly an ILS glide slope, and the like.

A typical AFCS comprises a flight director and fly-by-wire backdrive system. The system provides multichannel autopilot and flight director control functions for speed selection, altitude modes, heading/track modes, vertical speed/flight path angle modes, vertical/lateral flight management control selection, and fully automatic landing and go-around modes. The AFCS further provides for backdrive of the captain's and first officer's control columns and control wheels during all phases of the flight envelope, and will also backdrive the rudder pedals during autoland and go-around.

The AFCS communicates with the other major avionic system components via data buses 125, 135, 145, and 155. In certain embodiments, these data buses comprise ARINC 629 interfaces. Maintenance and fault isolation information is communicated to the aircraft central maintenance system via a directed maintenance protocol. In certain embodiments, each of the AFCS-computers 150 comprise three processors; dual-dissimilar AAMP and Intel processors supporting the high integrity requirements for the backdrive control system and the verified FCP-2000 microprocessor.

A typical AFCS includes an Autopilot Flight Director System 110 which performs the data computations necessary to control the automatic pilot functions, the automatic landing functions, and backdrive the pilot controls. In certain embodiments, the Flight Director System 110 comprises one or more verified FCP-2000 microprocessors 113 in an architecture that is tolerant to neutron single event upsets (NSEU).

A typical AFCS further includes a Mode Control Panel element comprising a portion of interface 120 which provides the primary means of flight crew interface with the AFCS system. Modes are selected via tactile feel pushbutton switches. Settings displayed via backlit LCDs.

A typical AFCS further includes a Backdrive Control Actuator element comprising a portion of interface 120 which provides mechanical actuation of the control wheel, control column, and rudder pedals. This functionality is driven by backdrive electronics within the AFCS system and includes 6 servos—2 wheel servos, 2 column servos, and 2 pedal servos.

A traditional Instrument Landing System (“ILS”) comprises both ground-based and on-board hardware and software that allows an aircraft to intercept a navigational beacon, i.e. the Localizer, and to track that Localizer inbound to a selected runway all the while gradually descending according to a received Glideslope signal. A Category III ILS system comprises what is sometimes referred to as an “autoland” capability wherein the aircraft lands itself without any pilot input or control. The ILS equipment on the ground sends signals to the equipment in the aircraft for guidance. The aircraft utilizes Flight Director 110 comprising controller 113 and instructions/functions 115 to automatically control the aircraft's flight control surfaces and speed using actuator systems 140 to descend and land at the proper place on the runway. The use of Category III ILS allows aircraft to land in 99.9% of situations that lead to poor visibility.

In certain situations, a published Cat III ILS approach only permits pilots in Cat III certified aircraft to land if a specified forward visibility, or “runway visual range,” is reported at the destination field. Even though the aircraft can land itself on the runway, sufficient visibility need exist to subsequently steer the aircraft from the runway to the arrival terminal. In that regard, a Cat III ILS approach allows a pilot to land an aircraft with little to no visual observation of the runway if the requisite runway visual range exists, i.e. if the forward visibility on the ground is sufficient to steer the aircraft to the terminal.

In addition, certain aircraft now, or will in the near future, comprise such an autoland capability based upon signals received from a plurality of global positioning satellites (“GPS”). Many precision GPS approaches have been published and/or are in the process of being certified.

A typical AFCS further comprises a database, such as database 157, comprising information relating to every airport along the aircraft's flight path. In the event of an on-board emergency, the AFCS 105 can expeditiously search database 157 and immediately provide the location of, directions to, a runway map of, and communications frequencies for, the nearest 10 airports.

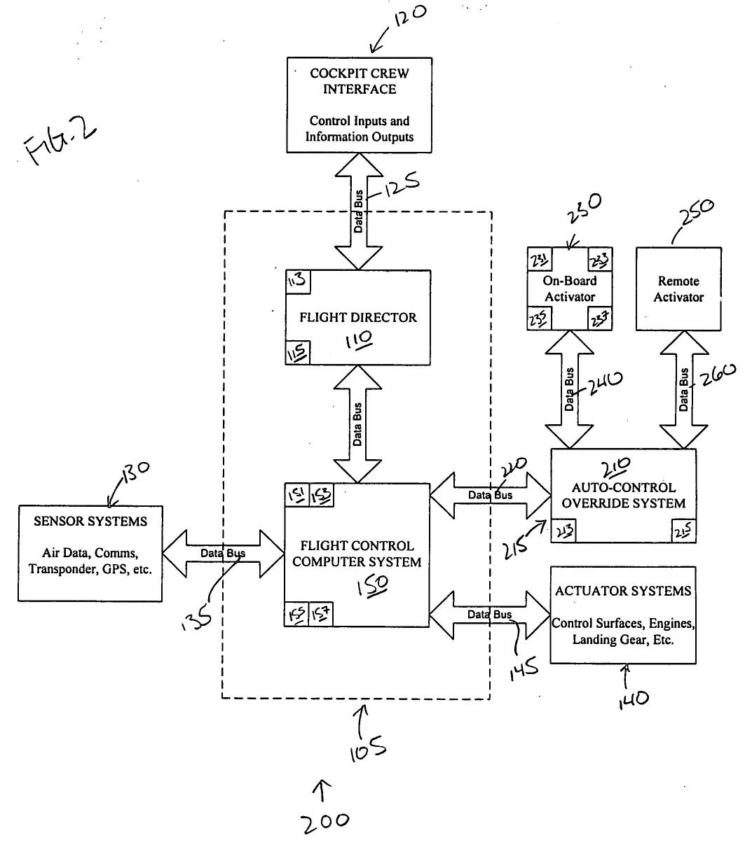

Referring now to FIG. 2, Applicants' on-board aircraft control system 200 includes the elements of system 100 in combination with Applicants' auto-control override system (“Override System”) 210. Override System 210 comprises processor 213 and microcode/instructions 215. Override System 210 communicates with AFCS 105 via data bus 220. When activated, Override System 210 interrupts data bus 125 such that all flight control commands and inputs, whether those control commands/control inputs are mechanical, electromechanical, electrical, analog, and/or digital, originating from the cockpit are not provided to Flight Director 110.

In the illustrated embodiment of FIG. 2, Override System 210 is disposed in an appliance 215 external to AFCS 105 (FIG. 1). In other embodiments, Override System 210 is integral with AFCS 105. In still other embodiments, Override System 310 comprises hardware, firmware, and/or software that is implemented into the various elements of AFCS 105.

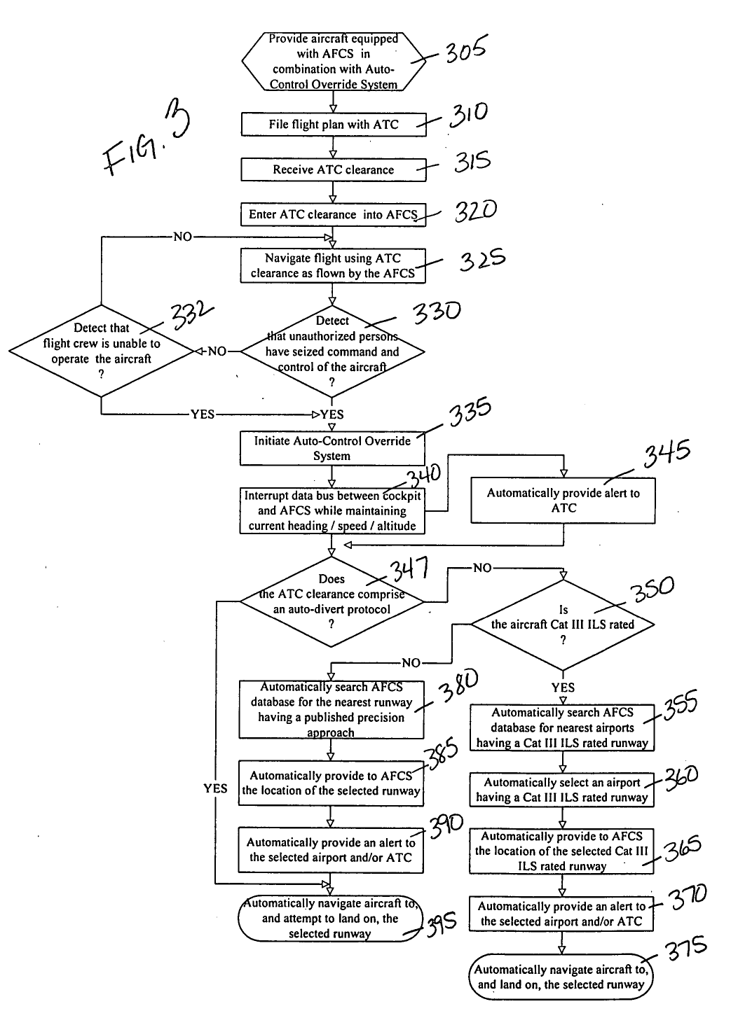

FIG. 3 summarizes Applicants' method to irrevocably take control of the aircraft and land that aircraft using Override System 200. Referring now to FIG. 3, in step 305 Applicants' method provides an aircraft equipped with an AFCS and Applicants' auto-control override system.

As those skilled in the art will appreciate, the airspace above Flight Level 180, corresponding approximately to a barometric elevation of 18,000 feet, through Flight Level 600 (60,000 feet) is designated Class A airspace. 14 C.F.R. Part 71 Section 31. Class B airspace includes the airspace from the surface to 10,000 feet that surrounds the busiest airports in the U.S. 14 C.F.R. Part 71 Section 41. A clearance from Air Traffic Control (“ATC”) is required to operate an aircraft in Class A airspace. 14 C.F.R. Part 91 Section 135(a). In addition, a clearance from ATC is required to operate an aircraft in Class B airspace. 14 C.F.R. Part 91 Section 131(a)(1). In order to receive an ATC clearance, a flight plan must be proffered to ATC either orally or in writing.

In step 310, the flight crew, or persons acting on their behalf, file a flight plan with ATC/FAA, wherein that flight plan comprises, inter alia, airport of origin, destination airport, requested departure time, expected arrival time, preferred routing(s), preferred altitude(s), a Special Equipment Suffix indicating certain on-board equipment, and the like. As those skilled in the art will appreciate, Special Equipment Suffixes A, B, C, D, G, I, T, U, X, and Y, are currently used. For example, Special Equipment Suffix “X” indicates that the aircraft does not have a transponder. Special Equipment Suffix “C” indicates RNAV capability in combination with a transponder with Mode C capability. In certain embodiments of Applicants' method, the flight plan filed by the flight crew comprises a Special Equipment Suffix that indicates that the aircraft of step 305 is equipped with Applicants' auto-control override system.

In step 315, in response to the filed flight plan, and based upon, inter alia, other flights in the area and weather, ATC issues a clearance comprising, inter alia, a designated transponder code, wherein that ATC clearance may or may not comprise the requested routing(s), altitudes, departure times, and/or arrival times. In embodiments of Applicants' method wherein the flight plan of step 310 comprises a Specific Equipment Suffix indicating that the aircraft of step 305 comprises Applicants' auto-control override system, the ATC clearance of step 315 comprises a designated auto-divert protocol, wherein that auto-divert protocol comprises, inter alia, one or more pre-selected diversion airports/runways.

In step 320, the flight crew enters the ATC clearance of step 315 into the on-board AFCS, such as AFCS 105. By “flight crew,” Applicants mean the pilot-in-command, and optionally one or more of a first officer, i.e. co-pilot, a second officer, i.e. a navigator, and the like. In certain embodiments, that ATC clearance is stored in computer system 150 as ATC clearance 155. In certain embodiments, step 320 comprises entering the auto-divert protocol specified in the ATC clearance of step 315.

In step 325, the flight is initiated as authorized by ATC, and proceeds in accordance with the clearance of step 315. In certain embodiments, step 325 is performed by the on-board AFCS. In certain embodiments, in step 325 processor 215 disposed in computer system 150, using microcode/instructions 153, provides routing instructions from ATC clearance 155 to processor 113 disposed in Flight Director 110, wherein processor 113, using instructions/microcode 115, operates actuator systems 140 to navigate the ATC clearance. In certain embodiments, step 325 further comprises receiving an amended clearance from ATC, entering that amended clearance into ATC clearance 155, and flying that amended clearance.

In step 330, Applicants' method monitors whether one or more unauthorized persons have obtained command and control of the aircraft. In operation, step 330 is continuously being performed by all members of the flight crew, including the pilots, navigator, and flight attendants.

In certain embodiments, step 330 comprises, inter alia, continuously monitoring the aircraft's transponder. As those skilled in the art will appreciate, the transponder code 7500 indicates a hijacking. In certain embodiments, Applicants' auto-control override system 210 (FIG. 2) detects in step 330 that unauthorized person have seized command and control of the aircraft by determining that 7500 has been entered into the aircraft's transponder system.

In certain embodiments, Applicants' method detects in step 330 if one or more unauthorized persons have obtained command and control of the aircraft by receiving a signal from an on-board activator 230 disposed in the cockpit, wherein that activator is in communication with Applicants' auto-control override system via a data bus 240. In certain embodiments, Applicants' method detects in step 330 if one or more unauthorized persons have obtained command and control of the aircraft by receiving a signal from an on-board activator 230 disposed in the galley portion of the aircraft, wherein that activator is in communication with Applicants' auto-control override system via a data bus 240.

In certain embodiments, activator 230 optionally comprises one or more of a key receptacle 231, a magnetic card reader 233, a fingerprint recognition device 235, and/or a retinal scan detector 237. In certain embodiments, activator 230 sends to Override System 210 (FIG. 2) an activating signal in response to insertion of a key into a key receptacle, such as receptacle 213, and then rotating that inserted key. In certain embodiments, activator 230 sends an activating signal to Override System 210 in response to detecting and verifying a magnetic card using a magnetic card reader, such as magnetic card reader 233.

In certain embodiments, activator 230 sends an activating signal to Override System 210 in response to detecting and verifying an authorized fingerprint using fingerprint reader 235. In certain embodiments, finger print reader 235 comprises a U.are.U 4000 USB fingerprint reader sold in commerce by Digital Persona, Inc. In these embodiments, finger print reader 235 further comprises software, such as DigitalPersona IDentity Engine, sold in commerce by Digital Persona, Inc., wherein that software engine comprises algorithms that provide fingerprint verification. In these embodiments, a flight crew member places a finger on a reader window, and reader 235 automatically captures and encrypts the finger print image before sending it to the DigitalPersona IDentity Engine for verification using stored data comprising the finger prints for each of the flight crew, as defined hereinabove, and optionally the finger prints for each of the cabin crew, i.e. flight attendants.

In certain embodiments, activator 230 sends an activating signal to Override System 210 in response to detecting and verifying an authorized retinal scan using retinal scanner 237. In these embodiments, retinal scanner 237 comprises hardware and software to obtain a scan of certain features of a user's eye, and to compare that scan with stored data comprising the retinal scans for each of the crew, as defined hereinabove, and optionally the retinal scans for each of the cabin crew, i.e. flight attendants. By “retinal scan,” Applicants mean data comprising an iris scan and/or data comprising a retinal scan.

Biometrics which analyze the complex and unique characteristics of the eye can be divided into two different fields: iris biometrics and retina biometrics. The iris is the colored band of tissue that surrounds the pupil of the eye. An iris recognition system uses a video camera to capture the sample while the software compares the resulting data against stored templates.

The retina is the layer of blood vessels at the back of the eye. Retinal scans are performed by directing a low-intensity infrared light to capture the unique retina characteristics. An area known as the face, situated at the center of the retina, is scanned and the unique pattern of the blood vessels is captured.

If Applicants' method detects in step 330 that unauthorized persons have obtained command and control of the aircraft, then Applicants' method transitions from step 330 to step 335. If Applicants' method determines in step 330 that one or more unauthorized persons have not obtained command and control of the aircraft, then the method transitions from step 330 to step 332 wherein the method determines if the flight crew is unable to operate the aircraft. In operation, step 332 is continuously being performed by Applicants' auto-control override system.

As those skilled in the art will appreciate, a loss of cabin pressurization while at altitudes higher than, for example, FL 180 can result in rapid loss of consciousness. Such a depressurization can lead to flight crew incapacitation and the inability of that flight crew to operate the aircraft. In certain embodiments, Applicants' auto-control divert system 210 determines that a total absence of command/control inputs from interface 120 (FIGS. 1, 2), in combination with a total failure of the aircraft crew to respond to radio communications, throughout a designated time interval, such as for example for 30 minutes, indicates that the flight crew is unable to operate the aircraft. If Applicants' method determines in step 332 that the flight crew remains able to operate the aircraft, then the method transitions from step 332 to step 325 and continues as described herein.

In certain embodiments of Applicants' method, the determination of step 330 that one or more unauthorized persons have seized command and control of the aircraft is made by ATC. In certain embodiments of Applicants' method, the determination of step 332 that the flight crew is unable to operate the aircraft is made by ATC.

In certain embodiments of Applicants' method, ATC detects in step 330 that unauthorized persons have obtained command and control of the aircraft upon receiving a transponder code 7500 from the aircraft. In response, ATC can activate the on-board auto-control override system as described hereinbelow.

As those skilled in the art will appreciate, the transponder code 7700 indicates an in-flight emergency. In addition, use of the transponder code 7700 for about 1 minute followed by a continuous use of the transponder code 7600 indicates a communication failure on the aircraft. In certain embodiments of Applicants' method, ATC determines in step 332 that the flight crew is unable to operate the aircraft based upon receiving continuous transponder code 7700, but not transponder code 7600, in combination with a total failure of the crew to respond to radio communications. In other embodiments, ATC determines in step 332 that the flight crew is unable to operate the aircraft based upon one or more visual determinations made by flight crews operating other aircraft flying in near vicinity to the subject aircraft, and observing unconscious crew members in the cockpit.

If Applicants' method detects in step 330 that one or more unauthorized persons have seized control of the aircraft, or determines in step 332 that the flight crew is not able to operate the aircraft, then the method transitions to step 335 wherein the method activates the auto-control override system, such as Override System 210 (FIG. 2). In embodiments wherein the detection of step 330 comprises receiving one or more signals from an on-board activator 230, then steps 330 and 335 are performed synchronously. In embodiments wherein the detection of step 332 is performed by the on-board auto-control override system, then steps 332 and 335 are performed synchronously. In embodiments, wherein the detection of either step 330 or step 332 is performed by ATC, then in step 335 ATC provides a signal to Applicants' auto-control override system 210 using remote activator interface 250 and data bus 260. In certain embodiments, remote activator interface 250 comprises a portion of the aircraft's communication system. In other embodiments, remote activator interface 250 comprises a radio receiver integral with the auto-control override system 210.

Applicants' method immediately transitions from step 335 to step 340 wherein the data bus, such as data bus 125 (FIGS. 1, 2), interconnecting all control functions originating in the cockpit and the AFCS, such as AFCS 105 (FIGS. 1, 2), is interrupted. In certain embodiments, in step 340 Override System 210 provides instructions to AFCS 105 to interrupt data bus 125. In certain embodiments, processor 213 using instructions/ microcode 215 provides one or more signals via data bus 220 to processor 251 which uses instructions 253 to provide one or more signals via data bus 155 to processor 113 to interrupt data bus 125.

Using Applicants' method, step 335 is irreversible. Subsequent to performing step 335, data bus 125 cannot be reestablished without manually disabling auto-control override system 210. As a general matter, one or more control heads comprising various data input devices such as knobs, switches, touch screens, and the like, in combination with various data display devices, such as LED arrays, display screens, and the like, are disposed in the cockpit area, and are interconnected with the Flight Director module 110 and the AFCS module 150, wherein those modules 110 and 150 are disposed within the structure of the aircraft and are not accessible via the cockpit. Therefore, even though the cockpit crew, or others, have access to the one or more control heads interconnected with Flight Director 110 and/or AFCS 150, such access cannot be used to override auto-control system 210. In embodiments wherein physical access to Flight Director 110 and/or AFCS could be made by the cockpit crew, or others, while the aircraft is in flight, auto-control override system 210 is disposed in a separate appliance, such as appliance 215 (FIG. 2), wherein physical access to that appliance 215 cannot be made by the cockpit crew, or others, while the aircraft is in flight.

Upon the interruption of the cockpit/AFCS data bus 125, no control inputs originating in the cockpit are received by AFCS 105. In certain embodiments, step 340 further comprises maintaining the current heading, speed, and altitude by AFCS 105. In other embodiments, step 340 comprises navigating ATC clearance 155.

In certain embodiments, Applicants' method transitions from step 340 to step 347. In other embodiments, Applicants' method transitions from step 340 to step 345 wherein the method automatically alerts ATC that the aircraft is no longer under pilot control. In certain embodiments, the auto-divert protocol portion of the ATC clearance comprises a designated transponder code which is immediately implemented by Override System 210 thereby alerting ATC that the aircraft is no longer under pilot control.

In certain embodiments, step 345 is performed by flight director 110. In other embodiments, step 345 is performed by computer 150. In other embodiments, step 345 is performed by Override System 210.

Applicants' method transitions from step 345 to step 347, wherein Applicants' method determines whether the ATC clearance 155 comprises an auto-divert protocol. If Applicants' method determines in step 347 that ATC clearance 155 comprises an auto-divert protocol, then the method transitions from step 347 to step 395 wherein the method implements that auto-divert protocol and automatically navigates to, and attempts to land at, the designated diversion runway/airport.

If Applicants' method determines in step 347 that the ATC clearance 155 does not comprise an auto-divert protocol, then the method transitions from step 347 to step 350 wherein the method determines if the aircraft of step 305 is Cat III ILS approved. In certain embodiments, step 350 is performed by flight director 110. In other embodiments, step 350 is performed by computer 150. In other embodiments, step 350 is performed by Override System 210.

If Applicants' method determines in step 350 that the aircraft is Cat III ILS approved, then the method transitions from step 350 to step 355 wherein the method searches the AFCS database, such as database 157, to locate the nearest airport(s) having one or more Cat III ILS approved runways. In certain embodiments, step 355 comprises locating only the closest airport having one or more Cat III ILS approved runways. In other embodiments, step 355 comprises locating a plurality of airports within about 50 nautical miles of the aircraft's current position having one or more Cat III ILS approved runways. In certain embodiments, step 355 is performed by flight director 110. In other embodiments, step 355 is performed by computer 150. In other embodiments, step 355 is performed by Override System 210.

Applicants' method transitions from step 355 to step 360 wherein the method automatically selects an airport having one or more Cat III ILS approved runways. In embodiments wherein step 355 comprises locating only the closest airport having one or more Cat III ILS approved runways, then steps 355 and 360 are merged into a single step. In certain embodiments, in step 360 Applicants' method selects an airport having one or more Cat III ILS runways, wherein that selected airport is not the closest airport, wherein that selected airport is chosen based upon factors such as, for example, expected airport traffic, population density in the vicinity of the airport, runway alignment, weather, and the like

In the event the aircraft of step 305 is commandeered by one or more terrorists, those terrorists may have placed one or more explosive devices aboard the aircraft. In embodiments, wherein step 355 comprises locating a plurality of airports within about 50 nautical miles of the aircraft's current position having one or more Cat III ILS approved runways, in certain embodiments step 360 comprises selecting one of those located airports of step 355, wherein the selected airport represents the minimum risk of personal injury and/or property damage to persons and structures on the ground in the event one or more on-board explosive devices are detonated during the approach, landing, or roll out of the aircraft. In certain embodiments, step 355 comprises selecting the nearest military airport.

Applicants' method transitions from step 360 to step 365 wherein the method automatically provides to AFCS 105 the location of, and vectors to intercept the approach course to, the selected runway. In certain embodiments, step 365 is performed by flight director 110. In other embodiments, step 365 is performed by computer 150. In other embodiments, step 365 is performed by Override System 210.

In certain embodiments, Applicants' method includes step 370 wherein the method automatically provides an alert to the airport selected in step 360, and/or to ATC. As those skilled in the art will appreciate, the Federal Aviation Regulations provide, inter alia:
When an ATC clearance has been obtained, no pilot in command may deviate from that clearance unless an amended clearance is obtained, an emergency exists, or the deviation is in response to a traffic alert and collision avoidance system resolution advisory . . . Except in an emergency, no person may operate an aircraft contrary to an ATC instruction in an area in which air traffic control is exercised . . . . Each pilot in command who, in an emergency, or in response to a traffic alert and collision avoidance system resolution advisory, deviates from an ATC clearance or instruction shall notify ATC of that deviation as soon as possible. 14 C.F.R. Part 91 Section 123(a), (b), (c).

In certain embodiments, step 370 is performed by flight director 110. In other embodiments, step 370 is performed by computer 150. In other embodiments, step 370 is performed by Override System 210.

In step 375, Applicants' method automatically navigates the aircraft to, and lands on, the selected runway. Step 375 is performed by the on-board AFCS. Because the data bus interconnecting the cockpit and the AFCS has been interrupted, the aircraft cannot be operated after landing. This being the case, the aircraft will remain in position on the landing runway after completion of the “auto land” sequence.

If Applicants' method determines in step 350 that the aircraft is not Cat III ILS approved, then the method transitions from step 350 to step 380 wherein the method searches the AFCS database, such as database 157, to locate the nearest airport(s) having one or more published precision approaches. By “precision approach,” Applicants' mean an approach supported by hardware, firmware, and/or software, disposed in ground-based equipment, and/or disposed in on-board equipment, where that hardware, firmware, and/or software provides both lateral guidance and vertical guidance to the AFCS, such as AFCS 105. In certain embodiments, step 380 is performed by flight director 110. In other embodiments, step 380 is performed by computer 150. In other embodiments, step 380 is performed by Override System 210.

Applicants' method transitions from step 380 to step 385 wherein the method automatically selects an airport having one or more precision approaches, and automatically provides to the AFCS the location of, and vectors to intercept the approach course to, a selected runway having a precision approach. In certain embodiments, step 385 is performed by flight director 110. In other embodiments, step 385 is performed by computer 150. In other embodiments, step 385 is performed by Override System 210.

In certain embodiments, Applicants' method includes step 390 wherein the method automatically provides an alert to the airport selected in step 385, and/or to ATC. In certain embodiments, step 390 is performed by flight director 110. In other embodiments, step 390 is performed by computer 150. In other embodiments, step 390 is performed by Override System 210.

Applicants' method transitions from step 390 to step 395, wherein Applicants' method automatically navigates the aircraft to, and attempts to land on, the selected runway. Step 395 is performed by the on-board AFCS. Because the aircraft lacks the requisite hardware, firmware, and/or software comprising an “auto land” sequence, step 395 may include a controlled crash onto the runway selected in step 385.

The embodiments of Applicants' method recited in FIG. 3 may be implemented separately. Moreover, in certain embodiments, individual steps recited in FIG. 3 may be combined, eliminated, or reordered.

In certain embodiments, Applicants' invention includes instructions residing in an article of manufacture, such as for example and without limitation Flight Director 110, and/or Computer 150, and/or Override System 210, wherein those instructions are utilized by one or more controllers disposed in Flight Director 110, and/or Computer 150, and/or Override System 210, respectively, to performs steps 340, 345, 347, 350, 355, 360, 365, 370, 375, 380, 385, 390, and 395, recited in FIG. 3.

In other embodiments, Applicants' invention includes instructions residing in any other computer program product, where those instructions are executed by a computer external to, or internal to, AFCS 105 and/or Override System 210, to perform steps 340, 345, 347, 350, 355, 360, 365, 370, 375, 380, 385, 390, and 395, recited in FIG. 3. In either case, the instructions may be encoded in an information storage medium comprising, for example, a magnetic information storage medium, an optical information storage medium, an electronic information storage medium, and the like. By “electronic storage media,” Applicants mean, for example, a device such as a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention.

We claim:

1. A method to control the operation of an aircraft in flight, comprising the steps of:
providing an aircraft comprising a database comprising the location of one or more airports, an automated flight control system, a cockpit crew interface, and a first data bus interconnecting said automated flight control system and said cockpit crew interface;
interrupting said first data bus while said aircraft is in flight such that no signals originating from said cockpit crew interface are received by said automated flight control system;
selecting a diversion airport from said database;
flying by said automated flight control system said aircraft to said diversion airport; and
attempting by said automated flight control system to land said aircraft at said diversion airport.

2. The method of claim 1, wherein said automated flight control system comprises said database.

3. The method of claim 1, further comprising the step of detecting that one or more unauthorized persons have taken control of said aircraft, wherein said detecting step is performed prior to executing said interrupting step.

4. The method of claim 3, wherein:
said providing an aircraft step further comprising providing an aircraft comprising a transponder;
said detecting step further comprises detecting use of the transponder code 7500 while said aircraft is in flight.

5. The method of claim 3, wherein:
said providing an aircraft step further comprising providing an aircraft comprising one or more on-board activators wherein each of said one or more activators are in communication with said a different second data bus,
said detecting step further comprises receiving a signal from one of said one or more on-board activators.

6. The method of claim 5, further comprising the steps of:
said providing an aircraft step further comprising providing an aircraft comprising an on-board activator comprising a magnetic card reader;
detecting by said on-board activator an authorized magnetic card;
providing by said on-board activator a signal to said automated flight control system.

7. The method of claim 5, further comprising the steps of:
said providing an aircraft step further comprising providing an aircraft comprising an on-board activator comprising a finger print reader;
detecting by said on-board activator an authorized finger print;
providing by said on-board activator a signal to said automated flight control system.

8. The method of claim 5, further comprising the steps of:
said providing an aircraft step further comprising providing an aircraft comprising an on-board activator comprising a retinal scanner;
detecting by said on-board activator an authorized retinal scan;
providing by said on-board activator a signal to said automated flight control system.

9. The method of claim 1, further comprising the step of detecting that the flight crew is unable to operate said aircraft, wherein said detecting step is performed prior to executing said interrupting step.

10. The method of claim 1, further comprising the steps of:
filing a flight plan with air traffic control;
receiving prior to take off a clearance from air traffic control, wherein said clearance designates said diversion airport.

11. The method of claim 1, further comprising the steps of:
said providing an aircraft step further comprising providing an aircraft comprising an on-board activator comprising a receiver apparatus to receive activation signals from sir traffic control;
receiving an activation signal from air traffic control;
providing by said on-board activator a signal to said automated flight control system.

12. An article of manufacture disposed in an aircraft comprising a cockpit crew interface and a first data bus interconnecting said article of manufacture and said cockpit crew interface, said article of manufacture comprising a database comprising the location of one or more airports and a computer readable medium having computer readable program code disposed therein to control the operation of said aircraft in flight, the computer readable program code comprising a series of computer readable program steps to effect:
interrupting said first data bus while said aircraft is in flight such that no signals originating from said cockpit crew interface are received by said automated flight control system;
selecting a diversion airport from said database;
flying said aircraft to said diversion airport; and
attempting to land said aircraft at said diversion airport.

13. The article of manufacture of claim 12, said computer readable program code further comprising a series of computer readable program steps to effect detecting that one or more unauthorized persons have taken control of said aircraft.

14. The article of manufacture of claim 13, wherein aircraft further comprises a transponder, said computer readable program code further comprising a series of computer readable program steps to effect detecting use of the transponder code 7500 while said aircraft is in flight.

15. The article of manufacture of claim 12, wherein said aircraft further comprises one or more on-board activators wherein each of said one or more activators is in communication with said article of manufacture by a different second data bus, said computer readable program code further comprising a series of computer readable program steps to effect receiving a signal from said one or more on-board activators.

16. The article of manufacture of claim 12, wherein said aircraft further comprises an on-board activator comprising a receiver apparatus to receive activation signals from air traffic control, said computer readable program code further comprising a series of computer readable program steps to effect:
receiving an activation signal from air traffic control;
providing by said on-board activator a signal to said automated flight control system.

17. The article of manufacture of claim 12, said computer readable program code further comprising a series of computer readable program steps to effect detecting that the flight crew is unable to operate said aircraft.

18. A computer program product usable with a programmable computer processor having computer readable program code embodied therein to control the operation of an aircraft in flight, said aircraft comprising an automated flight control system, a database comprising the location of one or more airports, a cockpit crew interface, and a first data bus interconnecting said automated flight control system and said cockpit crew interface, comprising:
computer readable program code which causes said programmable computer processor to interrupt said first data bus while said aircraft is in flight such that no signals originating from said cockpit crew interface are received by said automated flight control system;
computer readable program code which causes said programmable computer processor to select a diversion airport from said database;
computer readable program code which causes said programmable computer processor to instruct said automated flight control system to fly said aircraft to said diversion airport; and
computer readable program code which causes said programmable computer processor to instruct said automated flight control system to attempt to land said aircraft at said diversion airport.

19. The computer program product of claim 18, further comprising computer readable program code which causes said programmable computer processor to detect that one or more unauthorized persons have taken control of said aircraft.

20. The computer program product of claim 19, wherein aircraft further comprises a transponder, further comprising computer readable program code which causes said programmable computer processor to detect use of the transponder code 7500 while said aircraft is in flight.

21. The computer program product of claim 18, wherein said aircraft further comprises one or more on-board activators, further comprising computer readable program code which causes said programmable computer processor to receive a signal from said one or more on-board activators.

22. The computer program product of claim 21, wherein said aircraft further comprises an on-board activator comprising a receiver apparatus to receive activation signals from air traffic control.

23. The computer program product of claim 18, further comprising computer readable program code which causes said programmable computer processor to detect that the flight crew is unable to operate said aircraft.
